(19) United States
(12) Patent Application Publication
(10) Pub. No.: US 2024/0034172 A1
(43) Pub. Date: Feb. 1, 2024

(54) Electrified Vehicle Charging System and Operating Method Thereof

(71) Applicants: Hyundai Motor Company, Seoul (KR); Kia Corporation, Seoul (KR)

(72) Inventors: Eui Hoon Chung, Anyang-si (KR); Young Jin Kim, Incheon (KR); Jung Hong Joo, Suwon-si (KR); Gyu Yeong Choe, Anyang-si (KR); Ji Han Lee, Hwaseong-si (KR)

(21) Appl. No.: 18/062,396

(22) Filed: Dec. 6, 2022

(30) Foreign Application Priority Data
Jul. 27, 2022 (KR) 10-2022-0093277

(51) Int. Cl. B60L 53/37; B60L 53/36

(52) U.S. Cl. CPC B60L 53/37; B60L 53/36

(57) ABSTRACT

An embodiment electrified vehicle charging system includes an actuator configured to maintain or change a vertical position, a horizontal position, or an angle of a power receiver provided in a vehicle and a position controller configured to determine a relative position and a relative angle of the power receiver relative to a power transmitter provided outside of the vehicle through a sensor and to perform an alignment control between the power transmitter and the power receiver through the actuator based on the relative position and the relative angle of the power receiver.

### CROSS-REFERENCE TO RELATED APPLICATIONS

This application claims the benefit of Korean Patent Application No. 10-2022-009327, filed on Jul. 27, 2022, which application is hereby incorporated herein by reference.

### TECHNICAL FIELD

The present disclosure relates to an electrified vehicle charging system and an operating method thereof.

### BACKGROUND

Recently, as interest in the environment increases, environment-friendly vehicles having an electric motor as a power source are increasing. An environment-friendly vehicle is also referred to as an electric vehicle and can be exemplified as a hybrid electric vehicle (HEV) or an electric vehicle (EV).

In the case of an electrified vehicle, a battery is mounted to receive power externally and charges the battery and uses the charged power to use the vehicle. Thus, factors related to battery charging, such as charging efficiency, have a significant effect on the performance of the electrified vehicle.

As one of charging technologies for improving the performance of an electrified vehicle, there is wireless charging through electromagnetic induction between a power receiver and a power transmitter. According to the technology, there is an advantage in that charging may be performed conveniently since there is no need to connect the vehicle and a charger by wire to charge the electrified vehicle.

For such a charging method, the wireless charging performance such as rechargeable power and efficiency varies significantly depending on the distance and angle between the power transmitter and the power receiver. Thus, the distance and angle between a transmission pad and a reception pad are varied according to various factors such as type of vehicle, the ground condition, and boarding or loading state, and thus it is difficult to maintain a constant wireless charging performance. Further, as there is a deviation in wireless charging performance, the charging time may be delayed, or the charging may be unexpectedly stopped.

Thus, there is a need for maintaining a distance and angle between the transmission pad and the reception pad in an aligned state.

The foregoing is intended merely to aid in the understanding of the background of embodiments of the present disclosure, and is not intended to mean that the present disclosure falls within the purview of the related art that is already known to those skilled in the art.

### SUMMARY

The present disclosure relates to an electrified vehicle charging system and an operating method thereof. Particular embodiments relate to an electrified vehicle charging system and an operating method thereof capable of improving charging efficiency when the electrified vehicle is wirelessly charged.

Embodiments of the present disclosure relate to an electrified vehicle charging system and an operating method thereof capable of improving charging efficiency when the electrified vehicle is wirelessly charged by aligning a power transmitter with a power receiver.

Technical features achievable by embodiments of the present disclosure are not limited to the technical features described above, and other technical features not described will be clearly understood by those skilled in the art to which the present disclosure pertains.

An electrified vehicle charging system according to an embodiment of the present disclosure includes an actuator capable of maintaining or changing at least one of a vertical position, a horizontal position, or an angle of a power receiver provided in a vehicle and a position controller determining a relative position and an angle of the power receiver with respect to the power transmitter of the outside of the vehicle through a sensor and performing an alignment control between the power transmitter and the power receiver through the actuator based on the determined result.

For example, the electrified vehicle charging system may further include a charging controller outputting an alignment control performance request when the alignment control preparation is completed by checking whether the alignment control preparation is completed, and the position controller may perform an alignment control when the alignment control performance request is outputted.

For example, the charging controller may determine whether the alignment control preparation is completed based on the distance between the vehicle and the power transmitter.

For example, the position controller may output the determined results of the position and angle of the power receiver, and the charging controller determines whether the alignment control is completed based on the position and angle of the power receiver outputted, so that a charging initiation request may be outputted when the alignment control is completed.

For example, the charging controller determines changes in alignment state of the power receiver based on the determined results of the position and angle of the power receiver outputted after the charging is initiated in the position controller and outputs the alignment performance request when the alignment state of the power receiver is confirmed to be changed. And the position controller may perform the alignment control when the alignment control performance request is outputted.

For example, the charging controller may be provided in the vehicle.

For example, the sensor may be provided at one or more points of the power receiver or power transmitter.

For example, the sensor may include at least one of a camera, a laser sensor, an ultrasonic sensor, or an electromagnetic sensor.

For example, the actuator may be connected at six or more points of the upper portion of the power receiver.

For example, the actuator may include at least one of a spring, a rail, or a motor.

For example, the actuator may include a suspension of the vehicle.

For example, the position controller may be provided in the vehicle.

A method for operating an electrified vehicle charging system according to an embodiment of the present disclosure includes determining a relative position and an angle of a power receiver with respect to a power receiver of the outside of a vehicle through a sensor and performing an alignment control between the power transmitter and the power receiver through an actuator that can maintain or change at least one of a vertical position, a horizontal position, or an angle of the power receiver provided in the vehicle based on the determined result.

For example, the method for operating the electrified vehicle charging system may further include determining whether a charging controller completed the alignment control preparation and outputting, by a charging controller, an alignment control performance request when the alignment control preparation is completed, wherein the performing an alignment control includes performing, by a position controller, the alignment control when the alignment control performance request is outputted.

For example, the determining whether the alignment control preparation is completed includes determining whether the alignment control preparation is completed by the charging controller based on the distance between the vehicle and the power transmitter.

For example, the method for operating the electrified vehicle charging system may further include outputting, by the charging controller, the determined results of the position and angle of the power receiver, determining whether the alignment control is completed based on the position and the angle of the power receiver outputted, and outputting a charging initiation request when the alignment control is completed.

For example, the method for operating the electrified vehicle charging system may further include determining, by the charging controller, changes in alignment state of the power receiver based on the determined results of the position and angle of the power receiver outputted after the charging is initiated and outputting, when the alignment state of the power receiver is confirmed to be changed, the alignment control performance request, wherein the performing the alignment control may include performing, by the position controller, the alignment control when the alignment control performance request is outputted.

Features attainable by embodiments of the present disclosure are not limited to the above-described features and other features which are not described herein will become apparent to those skilled in the art from the following description.

According to an embodiment of the present disclosure described above, when the electrified vehicle is wirelessly charged, the power receiver may be aligned in parallel with a specified height and position based on the power transmitter, thereby improving wireless charging performance. In addition, as the alignment process is performed automatically, the charging convenience may be improved.

Moreover, as the alignment state can be kept constant regardless of the charging environment, it is possible to optimize the design related to wireless charging, such as power transmitter/receiver, resonance network, and power converter, in one standard without considering various differences according to the alignment state, thereby improving efficiency of the charging system operation.

It will be appreciated by persons skilled in the art that the effects that can be achieved with embodiments of the present disclosure are not limited to what has been particularly described herein above and other advantages of embodiments of the present disclosure will be more clearly understood from the following detailed description taken in conjunction with the accompanying drawings.

### BRIEF DESCRIPTION OF THE DRAWINGS

FIG. 1 is a view showing a configuration of an electrified vehicle charging system according to an embodiment of the present disclosure.

FIG. 2 is a view showing a configuration of a sensor arranged on a power receiver in an electrified vehicle charging system according to an embodiment of the present disclosure.

FIG. 3 is a view showing a configuration of an actuator arranged on a power receiver in an electrified vehicle charging system according to an embodiment of the present disclosure.

FIG. 4 is a view showing an alignment configuration when there is a position deviation of a vertical axis in an electrified vehicle charging system according to an embodiment of the present disclosure;

FIG. 5 is a view showing an alignment configuration when there is an angle deviation of a horizontal axis in an electrified vehicle charging system according to an embodiment of the present disclosure; and

FIG. 6 is a flowchart showing an operation method of a power control system of a vehicle according to an embodiment of the present disclosure.

### DETAILED DESCRIPTION OF ILLUSTRATIVE EMBODIMENTS

Regarding embodiments of the present disclosure disclosed in this specification or application, the specific structural or functional description is merely illustrative for the purpose of describing the embodiments of the disclosure, and embodiments of the disclosure may be implemented in various forms and should not be construed as being limited to the embodiments set forth in this specification or application.

Because the embodiments of the disclosure may be variously modified and have various forms, specific embodiments will be illustrated in the drawings and described in detail in this specification or application. However, it should be understood that embodiments of the disclosure are intended not to be limited to the specific embodiments but to cover all modifications, equivalents or alternatives without departing from the spirit and technical scope of the present disclosure.

Unless defined otherwise, all technical and scientific terms used herein have the same meaning as commonly understood by one of ordinary skill in the art to which this inventive concept belongs. It will be further understood that terms defined in commonly used dictionaries should be interpreted as having a meaning that is consistent with their meaning in the context of the related art and will not be interpreted in an idealized or overly formal sense unless expressly so defined herein.

Hereinafter, embodiments of the present disclosure will be described in greater detail with reference to the accompanying drawings. In describing embodiments of the present disclosure, for ease of understanding, the same reference numerals are used to denote the same components throughout the drawings, and repetitive description on the same components will be omitted.

In the following description, with respect to constituent elements used in the following description, suffixes “module” and “unit” are given in consideration of only facilitation of description and do not have meaning or functions discriminated from each other.

In addition, in the following description of the embodiments disclosed in the present specification, a detailed description of known functions and configurations incorporated herein will be omitted when it may make the subject matter of the embodiments disclosed in the present specification rather unclear. In addition, the accompanying drawings are provided only for a better understanding of the embodiments disclosed in the present specification and are not intended to limit technical ideas disclosed in the present specification. Therefore, it should be understood that the accompanying drawings include all modifications, equivalents and substitutions within the scope and spirit of the present disclosure.

It will be understood that although the terms first, second, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless context clearly indicates otherwise.

In the present application, it will be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

In addition, a unit or a control unit in a name such as a motor control unit (MCU) and a hybrid control unit (HCU) is a term widely used in the name of a controller that controls a vehicle-specific function and does not imply to a general function unit.

A controller is a communication device that communicates with other controllers or sensors to control the function that it is responsible for, a memory that stores an operating system or logic commands and input/output information, and one or more processors that perform determination, calculation, decision, and the like, which is necessary for the control the function that is responsible therefor.

Hereinafter, an electrified vehicle charging system and an operation method thereof according to embodiments of the present disclosure are described in detail with reference to drawings.

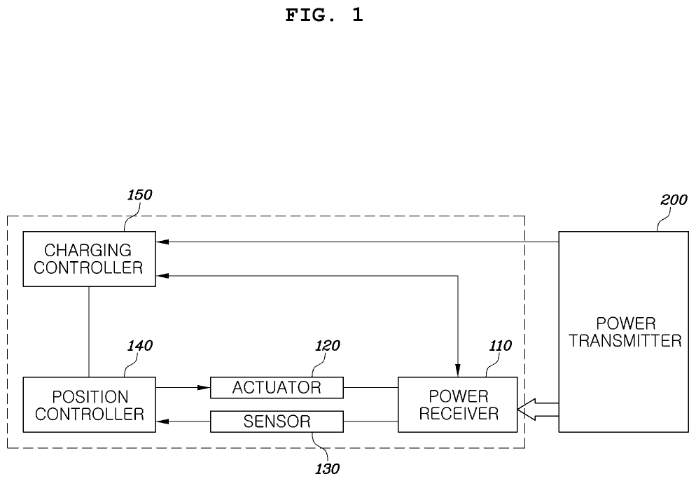

FIG. 1 is a view showing a configuration of an electrified vehicle charging system according to an embodiment of the present disclosure. An electrified vehicle charging system according to an embodiment of the present disclosure includes an actuator 120 capable of maintaining or changing at least one of a vertical position, a horizontal position, or an angle of a power receiver 110 provided in a vehicle 100 and a position controller 140 determining a relative position and an angle of the power receiver 110 with respect to a power transmitter 200 of the outside of the vehicle 100 through a sensor 130 and performing an alignment control between the power transmitter 200 and the power receiver 110 through the actuator 120 based on the determined result. Hereinafter, an electrified vehicle charging system according to an embodiment of the present disclosure will be described with reference to FIG. 1.

Referring to FIG. 1, the electrified vehicle charging system according to an embodiment of the present disclosure may include an electrified vehicle 100 and a power receiver 110 included therein, an actuator 120, a sensor 130, a position controller 140, a charging controller iso, and a power transmitter 200. The power transmitter 200 and the power receiver 110 no may be interpreted as a transmission pad and a reception pad, respectively. FIG. 1 mainly shows components related to the present embodiment of the present disclosure, and it is apparent to those skilled in the art that more or fewer components may be included in an actual implementation of a charging system.

In the wireless charging of the electrified vehicle through such components, the power transfer process will be described first. The power transmitter 200 receives an AC signal converted by energy in a switching device provided by a system power source. When the AC signal is received, a time-varying magnetic field is generated in the power transmitter 200, and a voltage is induced to the power receiver 110. Then, the power received through the power receiver 110 is converted into a DC voltage through a power conversion circuit and is used for charging the battery. In this case, the magnitude and efficiency of the power vary depending on the alignment state between the power transmitter 200 and the power receiver 110. Hereinafter, each component of the charging system will be described in detail.

First, the power transmitter 200 is provided at a charging station outside of the vehicle and positioned near the ground. The power transmitter 200 performs a function of transferring power to the power receiver 110, and to this end, communication with the vehicle 100 or the controller may be performed.

Subsequently, the power receiver 110 is provided in the electrified vehicle 100 and disposed on the lower portion of the vehicle 100 to correspond with the power transmitter 200. The power receiver 110 receives power from the power transmitter 200 and transfers power to the battery of the vehicle 100 to be charged. To this end, the power transmitter 200 and the power receiver 110 are positioned adjacent to each other. Primarily, the power receiver 110 is disposed near the power transmitter 200 through the movement of the vehicle 100 on which the power receiver 110 is mounted.

Meanwhile, the wireless charging efficiency may be degraded in the cases of: the distance from the power transmitter 200 increases due to the vertical position of the power receiver 110 being high, the horizontal position of the power receiver 110 moves away from the center of the power transmitter 200, and the power receiver 110 and the power transmitter 200 are not parallel to each other. Accordingly, for the wireless charging through the power transmitter 200 and the power receiver 110 to be performed at the highest efficiency point, the vertical position, the horizontal position, and the angle of the power receiver 110 are required to be aligned with respect to the power transmitter 200. However, the movement of the vehicle 100 alone is insufficient to allow the power receiver 110 to accurately correspond to the power transmitter 200, so that an additional operation (i.e., alignment control) of adjusting the position of the power receiver 110 is required.

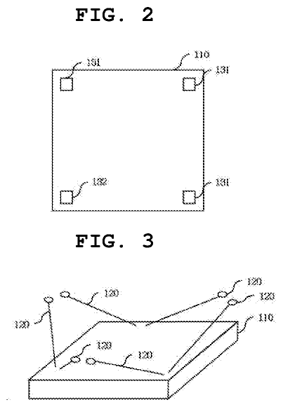

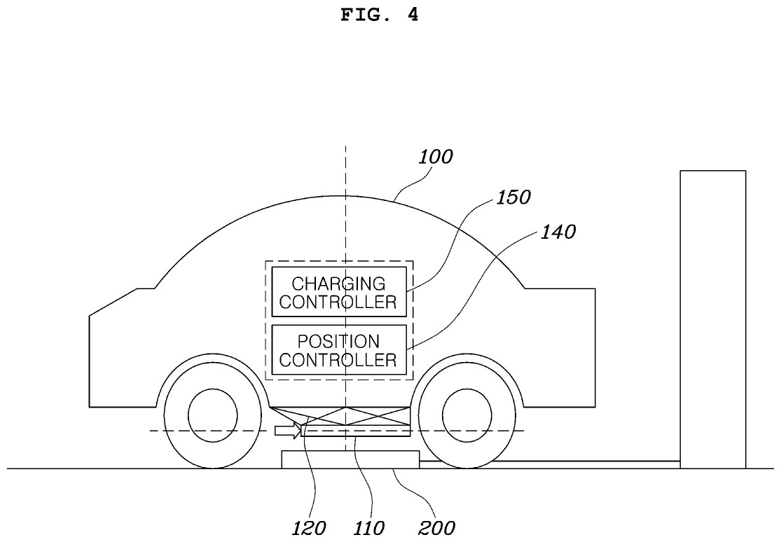

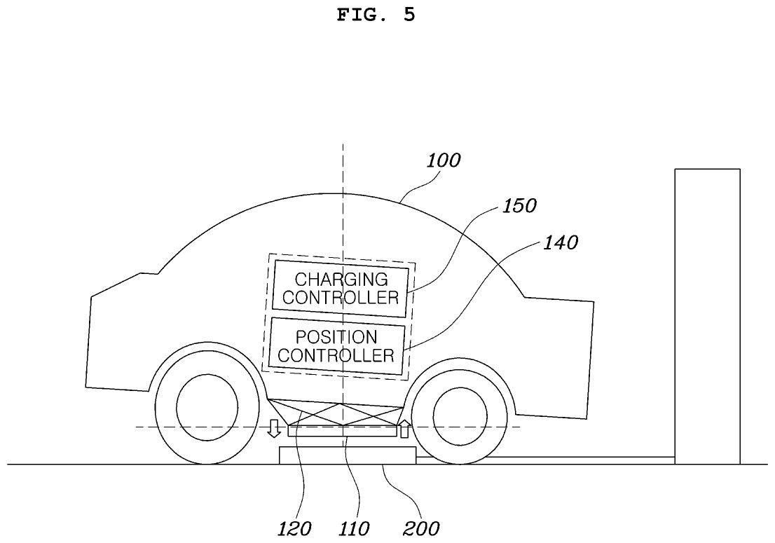

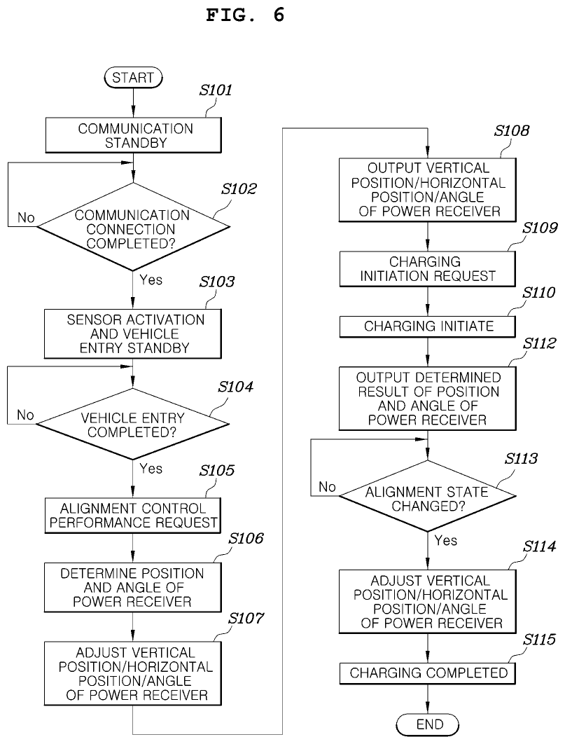

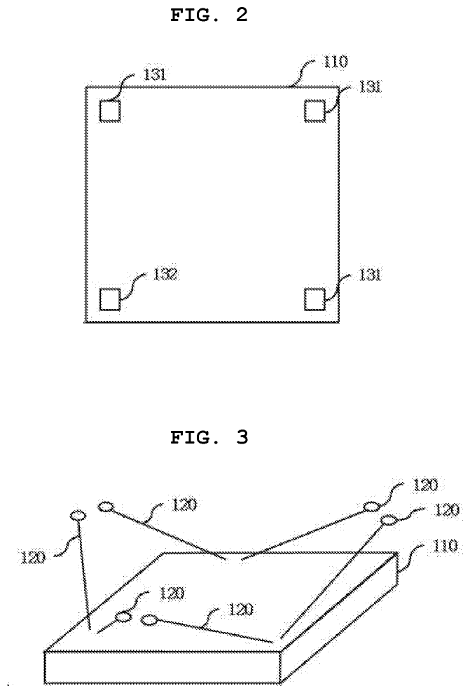

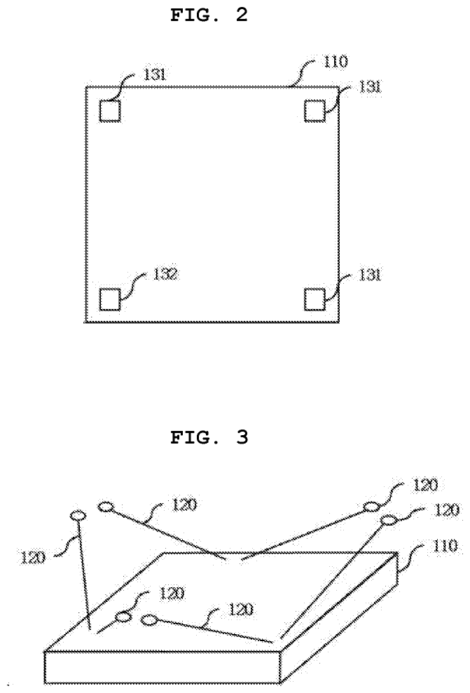

To this end, the sensor 130 detects the relative position and angle between the power receiver 110 and the power transmitter 200 so that the detection result may be used for alignment. In this case, the sensor 130 may be mounted on the power receiver 110 or the power transmitter 200. A detailed description of the sensor 130 is discussed below with reference to FIG. 2.

On the other hand, the position controller 140 determines the relative position and angle of the power receiver 110 with respect to the power transmitter 200 through the sensor 130 and performs alignment control between the power transmitter 200 and the power receiver 110 through the actuator 120 based on the determined result.

More particularly, the position controller 140 may determine the vertical position, the horizontal position, and the angle of the power receiver 110 with respect to the power transmitter 200 by obtaining a detection result from the sensor 130. In addition, the alignment state of the power receiver 110 and the power transmitter 200 may be determined through the determined vertical position, horizontal position, and angle of the power receiver 110. To what degree and which of the determined vertical position, horizontal position, and angle of the power receiver 110 has to be adjusted is determined. Based on the determined result, the position controller 140 may transmit an alignment signal including an element that needs to be adjusted for the power receiver 110 for alignment of the power receiver 110 and an adjustment degree to the actuator 120.

In addition, the position controller 140 may output determined results of the position and angle of the power receiver 110 through the sensor 130 in real-time or periodically. Thus, the alignment state may be monitored continuously. In particular, the output of the determined result may be maintained after the charging has initiated, so that it can be determined whether there is any change in alignment state due to boarding/deboarding of passengers, cargo loading, and the like.

The actuator 120 may maintain or change at least one of the vertical position, the horizontal position, or the angle of the power receiver 110. The actuator 120 may maintain or change the position and the angle of the power receiver 110 by inputting an alignment command from the position controller 140 and may be connected to the power receiver 110. A detailed description of the actuator 120 is discussed below with reference to FIG. 3.

By performing the alignment control, the vertical distance between the power transmitter 200 and the power receiver 110 may be maintained constant regardless of the ground clearance of the vehicle, boarding state of the passengers, and cargo loading state, and the like. In addition, regardless of the entry state of the vehicle, the horizontal position between the power transmitter 200 and the power receiver 110 may be aligned uniformly. Moreover, even when the power receiver 110 is not parallel to the power transmitter 200 according to the boarding state of the passengers, the cargo loading state, and the like, the angle may be adjusted so that the parallel alignment state may be maintained at all times.

Thus, the wireless charging performance through the power transmitter 200 and the power receiver 110 is improved, and by mitigating a deviation in charging performance, it may prevent problems such as a delay in charging time or an unexpected stop of charging. In addition, charging convenience may be improved as a separate alignment operation is unnecessary.

Meanwhile, the electrified vehicle charging system according to an embodiment of the present disclosure may further include a charging controller 150. The charging controller 150 may determine whether to initiate charging through the power transmitter 200 and the power receiver 110. To this end, communication with a transmission/reception communication unit (not shown) connected to the power receiver 110 or the power transmitter 200 may be performed.

In particular, the charging controller 150 may check whether the alignment control preparation of the electric vehicle 100 is completed and may output an alignment control performance request when the alignment control preparation is completed. Here, for example, whether to prepare for the alignment control may be determined based on whether the vehicle 100 has completed entering the charging position, a communication unit is connected to the power transmitter 200, the communication unit is connected to the power receiver 110, and a communication connection with the charging controller 150 is completed. In particular, the alignment control preparation may be determined based on the distance between the vehicle 100 and the power transmitter 200, and in this case, the distance between the vehicle 100 and the power transmitter 200 may be measured by the sensor 130. In the case of the distance between the vehicle 100 and the power transmitter 200 being less than the preset value, it may be assumed that the alignment is primarily configured by entering the charging position and determined that the alignment control preparation is completed. In the case of the alignment control preparation being completed, the charging controller 150 outputs the alignment control performance request, and the position controller 140 performs the alignment control by receiving the alignment control performance request. Thus, in the state of the vehicle being aligned primarily, the alignment control by the position controller 140 can be performed.

In addition, the charging controller 150 obtains the determined results of the position and the angle (that is, whether the alignment is completed) of the power receiver 110 output by the position controller 140 in real-time or periodically and outputs a charging initiation request based thereon. In particular, when the alignment between the power transmitter 200 and the power receiver 110 is completed based on the determined results of the position and the angle of the power receiver 110, a charging initiation request is output so that the charging of the electrified vehicle 100 is performed in the aligned state, thereby allowing charging efficiency to be ensured.

In addition, the charging controller 150 may check whether the alignment state of the power receiver 110 is changed based on the determined results of the position and the angle of the power receiver 110 output from the position controller 140 after charging is initiated. When the position and the angle of the power receiver 110 are maintained while alignment control is performed, additional alignment is unnecessary, but when the alignment state is changed due to any one of the positions and the angle of the power receiver 110 due to vehicle boarding/deboarding, and cargo loading, and the like, a re-alignment control is necessary. In this case, the charging controller 150 outputs the alignment control performance request, and the position controller 140 performs the re-alignment control according to the alignment control performance request. Thus, the alignment state between the power transmitter 200 and the power receiver 110 during charging is continuously monitored and maintained.

Meanwhile, in the charging system according to an embodiment of the present disclosure, the position controller 140 and the charging controller 150 may be implemented in distributed configurations, respectively, and may be implemented in one integrated controller that performs its functions. In addition, the position controller 140 and the charging controller 150 may include the electrified vehicle 100. When the electrified vehicle 100 is implemented so as to include the position controller 140 and the charging controller iso, the position controller 140 and the charging controller 150 may be implemented as separate controllers and may be implemented as a partial function of the controller mounted on the electrified vehicle 100, in general. In this case, the generally mounted controller may be a vehicle control unit (VCU) in the case of an electric vehicle or a hybrid control unit (HCU) in the case of a plug-in hybrid vehicle, but this is exemplary and is not limited thereto. In addition, contrarily, the position controller 140 and the charging controller 150 may be implemented in a configuration of being connected to the power transmitter 200 or the power receiver 110.

FIG. 1 describes each component and functions of the electrified vehicle charging system and according to an embodiment of the present disclosure, and a detailed method in which the power transmitter 200 and the power receiver 110 are aligned will be described with reference to FIG. 2.

FIG. 2 is a view showing a configuration of a sensor arranged on a power receiver 110 in an electrified vehicle charging system according to an embodiment of the present disclosure. The sensor 130 transmits the detection result to the position controller 140 so that the position controller 140 may determine the relative position and the angle of the power receiver 110.

Referring to FIG. 2, the sensor 130 may be disposed near each corner of the power receiver 110 and may be combined into three position sensors 131 and one angle sensor 132. In addition, the sensor 130 may be disposed to face the power transmitter 200 under the power receiver 110, and the arrangement and combination of the sensor 130 may determine the relative vertical position, horizontal position, and angle of the power receiver 110 to the power transmitter 200. However, this is exemplary, and the arrangement and combination of the sensor 130 are not necessarily limited thereto.

In addition, unlike depicted in FIG. 2, the sensor 130 may be disposed on the power transmitter 200, and in this case, it is appropriate to be disposed to face the power receiver 110 above the power transmitter 200 so as to identify the relative position and angle of the power receiver 110.

Meanwhile, the sensor 130 may include at least one of a camera, a laser sensor, an ultrasonic sensor, or an electromagnetic sensor. Accordingly, the sensor 130 may be configured in a single type and may be configured in a combination of two or more types of sensors. When the sensor 130 is configured as a camera, the position controller 140 may obtain image information from the camera and generate three-dimensional relative coordinates to determine the relative position and angle of the power receiver 110 with respect to the power transmitter 200. When the sensor 130 is configured as a camera, for the measurement accuracy, it is appropriate to use two or more cameras combined. In addition, when the sensor 130 is configured as a laser sensor or the like, the relative position and angle of the power receiver 110 may be determined based on the distance from each point of the power receiver 110 to the power transmitter 200, which is measured through the laser, and the like.

As the sensor 130 may determine the relative position and angle of the power receiver 110 with respect to the power transmitter 200, it is possible to determine whether the power transmitter 200 and the power receiver 110 are aligned, and which of the determined vertical position, horizontal position, and angle of the power receiver 110 has to be adjusted and to what degree is determined.

FIG. 2 describes the arrangement of the sensor 130 according to an embodiment of the present disclosure, and hereinafter, the actuator 120 will be described in detail with reference to FIG. 3.

FIG. 3 is a view showing a configuration of an actuator 120 arranged on a power receiver 110 in an electrified vehicle charging system according to an embodiment of the present disclosure. The actuator 120 may maintain or change at least one of the vertical position, the horizontal position, or the angle of the power receiver 110.

Referring to FIG. 2, the actuator 120 may be connected at six or more points of the upper portion of the power receiver 110. The actuator 120 is positioned between the power receiver 110 and the lower portion of the vehicle 100 and allows the power receiver 110 provided in the vehicle 100 to be aligned with the power transmitter 200. As six actuators 120 are connected to each of the points on the upper portion of the power receiver 110, the vertical position, the horizontal position, and the angle of the power receiver 110 may be adjusted, so that the alignment between the power transmitter 200 and the power receiver 110 may be more accurately performed.

For example, the actuator 120 may be configured to include at least one of a spring, a rail, or a motor. As shown in FIG. 3, six individual actuators may be disposed at each point on the upper part of the power receiver 110 to adjust a vertical position, a horizontal position, and an angle (i.e., a six-axis method), and three individual actuators may be combined to be implemented in a three-axis method.

In addition, the actuator 120 may be implemented as a suspension of the vehicle. When the suspension of the vehicle is an air suspension or uses an electronic control method, the vertical position and the angle of the power receiver 110 provided in the vehicle are adjusted together by adjusting the damping force or the height adjustment for the weight applied to each wheel when the vehicle is stopped. Accordingly, the charging system according to an embodiment of the present disclosure may adjust the alignment of the power receiver 110 by combining the suspension and the other components such as the spring and the rail of the actuator 120. Since the suspension basically configured in the vehicle 100 is used for alignment control, the configuration of the actuator 120 may be simplified, or a larger alignment range may be obtained through a combination with a separate actuator.

Meanwhile, since the actuator 120 and the sensor 130 may operate independently of the power receiver 110, the position and the angle of the power receiver 110 may be monitored even when the power is received through the power receiver 110, and alignment control may be performed when an alignment state changes.

FIGS. 1 to 3 are descriptions of the electrified vehicle charging system according to embodiments of the present disclosure, and hereinafter, the operations of the charging system based on the above-described components will be described.

FIG. 4 is a view showing an alignment configuration when there is a position deviation of a vertical axis in an electrified vehicle charging system according to an embodiment of the present disclosure.

Referring to FIG. 4, a vertical axis may be interpreted as a traveling direction of the vehicle 100. As shown, since the vehicle 100 is not sufficiently positioned on the power transmitter 200, the power receiver 110 and the power transmitter 200 are not aligned before the charging system according to an embodiment performs alignment control. When wireless charging is performed in such a state, charging efficiency may decrease. In order to solve this problem, even when the area of the power transmitter 200 is increased, the problem of increasing power loss persists. Thus, in order to ensure sufficient charging efficiency without any power loss, an alignment needs to be performed so that the center of the power receiver 110 coincides closely with the center of the power transmitter 200.

Accordingly, the electrified vehicle charging system according to an embodiment of the present disclosure may determine the relative horizontal position of the power receiver 110 through the sensor 130 to identify the longitudinal position deviation, and based on this, by adjusting the horizontal position of the power receiver 110 in the right direction in the drawing through the actuator 120, alignment between the power transmitter 200 and the power receiver 110 may be achieved.

The calibration of the vertical axis position deviation may also be performed through the movement of the vehicle 100 itself. However, when the driver drives and moves the vehicle 100, precise alignment is impossible, and the position of the power receiver 110 varies each time charging, and thus the alignment state cannot be maintained the same. In addition, even when the alignment is performed through driving control, there is a problem in that precision is lowered compared to adjusting the power receiver 110 itself. Meanwhile, in the case of the charging system according to an embodiment of the present disclosure, the position of the power receiver 110 may be precisely adjusted without adjusting the position of the vehicle 100 itself, thereby improving charging efficiency and improving convenience. In addition, since the alignment state can be maintained the same for each charging, the design of wireless charging may be unified and optimized on one criterion, thereby improving the charging efficiency as well as the operating efficiency of the charging system.

Unlike FIG. 4, alignment, when there is an angle deviation, will be described below with reference to FIG. 5.

FIG. 5 is a view showing an alignment configuration when there is an angle deviation of a horizontal axis in an electrified vehicle charging system according to an embodiment of the present disclosure.

Referring to FIG. 5, the horizontal axis may be understood as a vertical direction of the vehicle traveling direction. During wireless charging, there may be a deviation of a vertical axis and a horizontal axis according to a vertical position and a horizontal position of the power receiver 110, and an angle deviation of a horizontal axis of the power receiver 110 may occur due to a loading of a passenger or a cargo. Even when there is an angle deviation of a horizontal axis between the power transmitter 200 and the power receiver 110, charging efficiency is lowered, and thus it is necessary to align the power transmitter 200 and the power receiver 110 in parallel.

Accordingly, the charging system according to an embodiment of the present disclosure may determine an angle deviation through the sensor 130 and adjust an angle of the power receiver 110 through the actuator 120 to align the power transmitter 200 and the power receiver 110 in parallel. Thus, charging efficiency may be improved by precisely adjusting the angle of the power receiver 110, and the alignment process may be automated to improve convenience. In addition, since the alignment state can be maintained the same for each charging, the design of wireless charging may be unified and optimized on one criterion, thereby improving the charging efficiency as well as the production/management efficiency of the charging system.

In addition to the cases shown in FIGS. 4 and 5, the charging system according to an embodiment of the present disclosure may adjust a vertical position of the power receiver 110 to maintain a constant distance between the power receiver 110 and the power transmitter 200. In addition, even when there is a charge in the vertical position, the horizontal position, or the angle of the power receiver 110 due to passenger boarding/deboarding or unloading cargo after the start of the operation, alignment control is performed to maintain the same alignment state.

Hereinafter, a flowchart showing an operation method of a power control system of a vehicle according to an embodiment of the present disclosure will be described.

FIG. 6 is a flowchart showing an operation method of a power control system of a vehicle according to an embodiment of the present disclosure.

Referring to FIG. 6, first, the steps of determining an alignment control preparation before performing the alignment control are performed (S101 to S105). The charging controller 150 determines whether the communication connection is completed in the communication standby state (S101) with the power transmitter 200 and the power receiver 110 (S102), and when the communication connection is completed (Yes in S102) activates the sensor 130 and waits to enter the vehicle 100 (S103). Then, based on the distance from the power transmitter 200 detected by the sensor 130 when the vehicle 100 entry completion is identified (Yes in S104), the vehicle controller outputs the alignment control performance request (S105). Therefore, the alignment control by the position controller 140 or the like starts in a state where alignment is primarily performed through the entry of the vehicle 100.

The position controller 140 determines a position and an angle of the power receiver 110 according to an alignment control performance request by the charging controller 150 (S106) and transmits an alignment command to the actuator 120 based thereon. The actuator 120 receiving the alignment command maintains or changes at least one of a vertical position, a horizontal position, and an angle of the power receiver 110 based on the command so that the power transmitter 200 and the power receiver 110 are aligned (S107).

The sensor 130 continuously detects the position and angle of the power receiver 110 even after alignment of the power receiver 110 and transmits the detected position and angle to the position controller 140, and the position controller 140 determines the position and angle of the power receiver based on the detected position (S108). When the alignment is completed based on the determined result, the charging controller 150 outputs a charging initiation request (S109), and charging initiates as a communication unit connected to the power transmitter 200 receives the same and supplies power (S110).

The sensor 130 continuously detects and transmits the position and angle of the power receiver 110 to the position controller 140 even after charging has initiated, and based on this, the position controller 140 outputs the position and angle of the power receiver 110 based on the detected position (S112). The charging controller 150 determines whether the alignment state is changed based on the determined result (S113), and when the change is identified (Yes in S113), the position controller 140 maintains or changes at least one of a vertical position, a horizontal position, or an angle of the power receiver 110 through the actuator 120 based on the determined result (S114). The process may be performed continuously during the charging.

Then, when charging is fully charged, that is, when charging is completed (S115), the entire process is terminated.

According to an embodiment of the present disclosure described above, when the electrified vehicle is wirelessly charged, the power receiver 110 may be aligned in parallel with a specified height and position based on the power transmitter 200, thereby improving wireless charging performance. In addition, as the alignment process is performed automatically, the charging convenience may be improved.

Moreover, as the alignment status can be kept constant regardless of the charging environment, it is possible to optimize the design related to wireless charging, such as power transmitter/receiver, resonance network, and power converter, in one standard without considering various differences according to the alignment status, thereby improving efficiency of the charging system operation.

Although the preferred embodiments of the present disclosure have been disclosed for illustrative purposes, those skilled in the aft will appreciate that various modifications, additions and substitutions are possible, without departing from the scope and spirit of the disclosure as disclosed in the accompanying claims.

What is claimed is:

1. An electrified vehicle charging system, the system comprising:
an actuator configured to maintain or change a vertical position, a horizontal position, or an angle of a power receiver provided in a vehicle; and
a position controller configured to determine a relative position and a relative angle of the power receiver relative to a power transmitter provided outside of the vehicle through a sensor and to perform an alignment control between the power transmitter and the power receiver through the actuator based on the relative position and the relative angle of the power receiver.

2. The system of claim 1, further comprising a charging controller configured to output an alignment control performance request when alignment control preparation is completed by checking whether the alignment control preparation is completed, wherein the position controller is configured to perform the alignment control in response to the alignment control performance request being outputted.

3. The system of claim 2, wherein the charging controller is configured to determine whether the alignment control preparation is completed based on a distance between the vehicle and the power transmitter.

4. The system of claim 2, wherein:
the position controller is configured to output an updated position and an updated angle of the power receiver after the alignment control is performed; and
the charging controller is configured to determine whether the alignment control is completed based on the updated position and the updated angle of the power receiver and to output a charging initiation request in response to a determination that the alignment control is completed.

5. The system of claim 4, wherein the charging controller is configured to:
after charging is initiated, determine whether there is a change in an alignment state of the power receiver based on an additional determination of a current position and a current angle of the power receiver; and
output an additional alignment control performance request in response to a determination that there is the change in the alignment state of the power receiver, wherein the position controller is configured to perform an additional alignment control in response to the additional alignment control performance request being outputted.

6. The system of claim 2, wherein the charging controller is provided in the vehicle.

7. The system of claim 1, wherein the sensor is provided at one or more points of the power receiver.

8. The system of claim 1, wherein the sensor is provided at one or more points of the power transmitter.

9. The system of claim 1, wherein the sensor comprises a camera, a laser sensor, an ultrasonic sensor, or an electromagnetic sensor.

10. The system of claim 1, wherein the actuator is connected at six or more points of an upper portion of the power receiver.

11. The system of claim 10, wherein the actuator includes a spring, a rail, or a motor.

12. The system of claim 1, wherein the actuator comprises a suspension of the vehicle.

13. The system of claim 1, wherein the position controller is provided in the vehicle.

14. A method for operating an electrified vehicle charging system, the method comprising:
determining a relative position and a relative angle of a power receiver provided in a vehicle relative to a power transmitter provided outside of the vehicle, wherein determining the relative position and the relative angle of the power receiver is based on data obtained through a sensor; and
performing an alignment control between the power transmitter and the power receiver through an actuator that can maintain or change a vertical position, a horizontal position, or an angle of the power receiver provided in the vehicle based on the relative position and the relative angle of the power receiver.

15. The method of claim 14, further comprising:
determining whether an alignment control preparation is completed; and
outputting an alignment control performance request in response to a determination that the alignment control preparation is completed.

16. The method of claim 15, wherein performing the alignment control comprises performing the alignment control in response to outputting of the alignment control performance request.

17. The method of claim 16, wherein determining whether the alignment control preparation is completed and outputting the alignment control performance request are performed by a charging controller, and wherein performing the alignment control is performed by a position controller.

18. The method of claim 15, wherein determining whether the alignment control preparation is completed comprises determining whether the alignment control preparation is completed based on a distance between the vehicle and the power transmitter.

19. The method of claim 15, further comprising:
after performing the alignment control, determining an updated position and an updated angle of the power receiver;
outputting the updated position and the updated angle of the power receiver;
determining whether the alignment control is completed based on the updated position and the updated angle of the power receiver; and
outputting a charging initiation request in response to a determination that the alignment control is completed.

20. The method of claim 19, further comprising:
after charging is initiated, determining whether there is a change in an alignment state of the power receiver based on subsequently determined results of a current position and a current angle of the power receiver;
outputting an additional alignment control performance request in response to a determination of the change in the alignment state of the power receiver; and
performing an additional alignment control in response to the additional alignment control performance request being outputted.
